(19) United States
(12) Patent Application Publication
(10) Pub. No.: US 2009/0158423 A1
(43) Pub. Date: Jun. 18, 2009

(54) LOCKING MOBILE DEVICE CRADLE

(75) Inventors: Mark Orlassino, Centereach, NY (US); Ataul Sarker, Holtsville, NY (US); William R. Bang, Baiting Hollow, NY (US)

Correspondence Address: Motorola- Amin, Turocy & Calvin, LLP, 127 Public Square, 57th Floor, Key Tower, Cleveland, OH, 44114, US

(73) Assignee: SYMBOL TECHNOLOGIES, INC., Holtsville, NY (US)

(21) Appl. No.: 11/957,198

(22) Filed: Dec. 14, 2007

(51) Int. Cl. G06F 21/22

(52) U.S. Cl. 726/19

(57) ABSTRACT

Systems, devices and/or methods that facilitate an improved locking system are presented. An improved locking system can employ biometric sensing to facilitate improved mobile device security, more specificity in user access, specificity in levels of access, user accountability, selection of available devices, or combinations thereof, among many others. An improved locking system can employ remote oversight, multiple layers of locking, and inferential determinations to further facilitate a more transparent, effective, and substantial locking system for mobile devices. The improved locking system can be employed in devices, cradles, docking stations, and/or aftermarket products, and the like, among many others.

### TECHNICAL FIELD

The subject innovation relates generally to mobile devices, systems, and/or methods and more particularly to mobile device and cradle locking systems, devices, and/or methods to facilitate securing mobile devices against theft and misuse.

### BACKGROUND

Traditionally, systems for securing mobile devices against theft and misuse have required the use of key locks, passwords, or magnetic swipe cards. These systems, while effective in locking the device to a preferably less movable object, are also tedious and cumbersome. In some cases, if keys are lost, passwords are forgotten, or swipe cards are damaged, removing mobile devices from the cradle requires extraordinary lengths. As a result of these user unfriendly conventional locking systems, many users opt not to employ the locking system and can expose the devices to theft or misuse.

Additionally, different conventional locking conditions can be selected. For example, a laptop computer can be password protected and also be physically locked to a docking station. These systems then require a plurality of unlocking means to make the device usable and mobile. For example, a key to unlock the device from the cradle and a password to unlock the operating system for employee use.

Moreover, many traditional locking systems can be ignorant of environmental conditions in relation to a locking state. For example, where a laptop is unlocked for use on the corporate premises, that laptop can remain in an unlocked state even where it is removed to another location outside of the corporate premises. This can lead to serious breaches in data security.

Further, many locking systems are not user identity specific or permissive. For example, a set of five identical keys can be issued to five different employees so that they can access mobile radio devices for use on company property. Where each user's key is the same, an employee can access any or all of the mobile radios with their key. This can result in an inability to define which radio can be accessed by which employee, how many radios a single employee can take, and/or what services on the mobile radio a specific employee can use, among many others.

### SUMMARY

The following presents a simplified summary of the subject innovation in order to provide a basic understanding of some aspects described herein. This summary is not an extensive overview of the disclosed subject matter. It is intended to neither identify key or critical elements of the disclosed subject matter nor delineate the scope of the subject innovation. Its sole purpose is to present some concepts of the disclosed subject matter in a simplified form as a prelude to the more detailed description that is presented later.

Conventionally, locking systems for mobile devices can be inconvenient to use and can further result in circumvention of the traditional locking system to make access to the mobile device easier. This can create reduced mobile device security. For example, where a bar code scanner can employ a key lock to secure the scanner into a charging cradle when not in use, a user can opt not to lock the scanner to the charging cradle to eliminate the need to use the key the next time it is needed. Further, even where the scanner is locked in properly, the user can still be able to access data on the scanner without unlocking it defeating aspects of securing the scanner. Moreover, any of a number of different users can anonymously access the scanner where identical keys can be used. Numerous other deficiencies exist in conventional locking systems, including among others, locks that can be defeated (e.g., locks can be picked, lock cables can be cut, . . . ), locks that are not location sensitive (e.g., once unlocked devices can be used anywhere), locks can be cumbersome (e.g., a stiff cable lock can pull a device off a table, a large lock can weight more than the mobile device it is securing, . . . ), among many others.

In accordance with one aspect of the disclosed subject matter, an improved locking system can be employed to improve security, user access, user accountability, and owner control of mobile devices. The improved locking system can employ biometric sensors in the locking system to facilitate user selectivity, access selectivity, and more user friendly device access. For example, a facial recognition system can identify a specific user desiring to access a mobile device. Based on the user's permissions, recognition of the user's facial features can unlock the mobile device from the cradle, unlock the data access of the device, and set levels of device use (e.g., a grocery clerk can enter grocery orders only, a meat clerk can enter meat orders only, or a grocery manager can enter and edit grocery and meat orders, among many others.) Additionally, the locking system can be transparent to the user, for example, where a user approaches the scanner and the facial recognition system identifies the user, the device can appear unlocked to the user. In contrast, an unidentified user can be presented with a secured device and no apparent lock to tamper with or otherwise attempt to defeat.

Further, biometric locking does not require a user to possess a key, magnetic swipe card, or password. This can improve security because a key cannot be stolen or lent to another employee, a swipe card is not exposed to damage, and a password that can be forgotten isn't needed. Moreover, the specific user accessing the device can be positively identified and a chain of custody for the mobile device can be employed. This means that where a device is misused or damaged, the specific user that had access to the device at the time can be identified and held accountable. Additionally, where multiple devices are available for unlocking, a limited number of devices can be made available to the recognized user. For example, where five barcode scanners are available, recognition of an employee can unlock, for example, only one scanner, preserving the security of the remaining four scanners.

In another aspect, remote oversight of an improved locking system can allow remote management of access permissions to facilitate appropriate use of mobile devices and resource management. For example, where an employee is terminated at a satellite office, the terminated employee's access to mobile devices can be limited company wide by updating a permissions system. This permission system can be, for example, on a central server or updated at each satellite office. Further, interconnected permission systems can make available identification of devices “checked out” to specific employees. Moreover, levels of access on specific devices can be determined by a permission system, for example, managers can be allowed to edit saved orders on a mobile device while sales employees can be limited to only viewing entered orders on the mobile devices.

In accordance with another aspect of the disclosed subject matter, biometric locking can be enabled by a wide number of modalities including, but not limited to, fingerprints, hand geometry, iris or retinal identification, facial recognition, voice printing, genetic identification, or combinations thereof, among others. Additionally, multiple levels of identification can be employed in relation to the level of security required. For example, a mobile phone can be unlocked with a single user fingerprint, a PDA can be unlocked with a first fingerprint and a second voice print, or a laptop with sensitive information can be unlocked by a user retinal identification and a manager's first physical key and manager's second voice print. Numerous other permutations of biometric and/or traditional locking systems can be implemented within the scope of the subject innovation.

In another aspect, locking mechanisms can include, mechanical, electromechanical, magnetic, software or hardware locks, or combinations thereof, among others. Further, these locks can be part of a device, device mate, or after market lock system. For example, these locks can be included in a mobile device, cradle, docking station, cable lock, locking cabinet, multiport cradle or docking station, locking cover, locking net, locking bar, aftermarket locking tool, locking software, locking hardware, or combinations thereof, among others. For instance, a laptop can have a fingerprint reader installed at production that can actuate a software lock (e.g., use of the operating system can be fingerprint protected, . . . ) and can also actuate an electromechanical lock in the laptop that locks the laptop to a docking station. In another instance, a cell phone can be placed in a cradle having a physical lock that is actuated by a fingerprint scanner connected to the cradle by a USB cable. In a third instance, a barcode scanner can be placed in a multiport charging station having magnetic locks for each barcode scanner placed therein such that a voice print component can unlock the most charged barcode scanner for a recognized employee. Numerous other combinations are possible and all are considered within the scope of the disclosed subject matter.

In another aspect, inferential determinations can be employed in an improved locking system to facilitate improved mobile device security. Inferences can be, for example, based on time, location, historic device use, historic device access, user profiles or secondary user data, weather or other environmental conditions, emergency conditions, device charge conditions, device maintenance alerts, predicted device use, anticipated device servicing, sales, available device resources, or combinations thereof, among a nearly limitless number of other considerations. For example, where a laptop has been infected with a virus and contains emergency procedures, a user under normal conditions can be denied access to the device in anticipation of the laptop being repaired by the IT department. However, under emergency conditions it can be inferred that the need for access to the emergency procedures outweighs the potential threat from the virus and a user can be allowed access to the laptop. Further, where an emergency exists, it can be inferred that users lacking permissions to generally access the laptop can be allowed to access, for example, only the emergency procedures data on the laptop (e.g., a user with permissions can access all data on the laptop and a user without permissions cannot access any data on the laptop, however under emergency conditions a user without permissions can be allowed to access only the emergency procedures portions of the laptop). Inferences can add substantial depth to determinations of access and levels of access in an improved locking system.

To the accomplishment of the foregoing and related ends, the innovation, then, comprises the features hereinafter fully described and particularly pointed out in the claims. The following description and the annexed drawings set forth in detail certain illustrative embodiments of the innovation. These embodiments can be indicative, however, of but a few of the various ways in which the principles of the innovation can be employed. Other objects, advantages, and novel features of the innovation will become apparent from the following detailed description of the innovation when considered in conjunction with the drawings.

### BRIEF DESCRIPTION OF THE DRAWINGS

FIG. 1 is a high level diagram of a system that can facilitate improved locking of devices in accordance with an aspect of the subject matter disclosed herein.

FIG. 2 is a simplified diagram of an interrogation component that can facilitate improved locking of devices in accordance with an aspect of the subject matter disclosed herein.

FIG. 3 is a simplified diagram of a securing component that can facilitate improved locking of devices in accordance with an aspect of the subject matter disclosed herein.

FIG. 4 illustrates a diagram of an exemplary user device and cradle system employing an improved locking system that can facilitate improved locking of devices in accordance with an aspect of the disclosed subject matter.

FIG. 5 is a schematic illustration of a system to facilitate improved locking of devices in accordance with an aspect of the disclosed subject matter.

FIG. 6 illustrates a methodology that facilitates improved locking of devices in accordance with an aspect of the disclosed subject matter.

FIG. 7 illustrates a methodology that facilitates improved locking of devices in accordance with an aspect of the disclosed subject matter.

FIG. 8 illustrates a methodology that facilitates improved locking of devices in accordance with an aspect of the disclosed subject matter.

FIG. 9 illustrates an inferential methodology that facilitates improved locking of devices in accordance with an aspect of the disclosed subject matter.

FIG. 10 illustrates a block diagram of an exemplary electronic device that can facilitate improved locking of devices in accordance with an aspect of the disclosed subject matter.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the subject innovation. It is evident, however, that the disclosed subject matter can be practiced without these specific details. In other instances, well-known structures and devices are shown in block diagram form in order to facilitate describing the subject innovation.

Traditional mobile device locking systems generally are cumbersome, lack user friendly features, and provide limited security for mobile devices. For example, in a locking system using keys and mechanical locks, a single key can be shared among various users and obfuscate accountability for device misuse or theft. Further, a key can be lost or stolen and used by a person without permissions for access to the mobile devices. Even more problematic, where a key is lost, unlocking the device can become extremely difficult and time consuming (e.g., calling in a locksmith, getting a new key issued, having locks changed, . . . ). Moreover, where a traditional locking system is overly cumbersome, the locking system can be abandoned in favor of user convenience, exposing the mobile devices to theft and misuse where they are no longer secured. Additionally, where levels of permission are dynamic (e.g., an employee can have changing levels of access to mobile devices) use of traditional locking systems can result in delays in updating user access (e.g., where an employee is terminated, it can takes hours to days to get a key back from the employee, exposing the mobile devices to theft or misuse by the possessor of the outstanding key, . . . ).

In one aspect, an improved locking system can employ a biometric device to facilitate unlocking a device in accord with the disclosed subject matter. A biometric device can detect, for example, fingerprints, hand geometry, iris or retinal features, facial features, voice features, genetic features, or combinations thereof, among others. A biometric identification can typically be considered a unique identifier of the person presenting the biometric identifier. These unique identifiers can be employed to unlock mobile devices by causing, at least in part, unlocking of, for example, mechanical, electromechanical, magnetic, software or hardware locks, or combinations thereof, among others. For example, a voice print can be employed to unlock a cell phone from a charging cradle, unlock software to allow use of the cell phone in a limited manner (e.g., emergency calls, calls to specific telephone numbers, access to a limited number of stored contacts, . . . ), unlock all features of the cell phone for use, or combinations thereof, among others.

In another aspect, biometric locking can be combined with other locking techniques (e.g., card key locking, PIN locking, dongle locking, mechanical key locking, . . . ) to provide further enhanced device security. For example, a voice print and PIN number can be required to unlock a PDA from a synchronization cradle and sign into the operating system for use. Further, multiple biometric locks can also be combined with other locking systems to provide enhanced device security. For example, a first user fingerprint and a second manager fingerprint can be required to unlock a laptop from a docking station for use.

In another aspect, the improved locking system can be used to unlock various levels of access within a device or system. For example, a fingerprint can be employed to distinguish between users and allow differing levels of device use. For instance, a price checking barcode scanner can be unlocked by a manager fingerprint to give wholesale and retail pricing, while the same device can be unlocked by a sales associate to reveal only retail pricing. Similarly, a laptop can be unlocked by a user fingerprint, but allow access only to specific user profiles depending on the identified fingerprint (e.g., user A can unlock the laptop and access only user A profile while user B can unlock the laptop and access only user B profile).

In another aspect, the unique identifier can be employed to track device-user access and improve user accountability. For example, where a user voiceprint unlocks a laser scanner, the user can be determined to be responsible for the scanner until it is returned to and relocked into the laser scanner charger. Further, where multiple devices are presented to the user (e.g., a cradle with, for example, 5 cell phones charging), the voiceprint can identify the user and assign the most appropriate cell phone by unlocking only the designated phone (e.g., a user can be assigned a phone with the most recharged battery, a phone with specific features needed by the identified user, . . . ).

In another aspect, remote oversight can be employed in an improved locking system to facilitate more secure device management. In an aspect, the unique biometric identifier can reduce the number of discrete keys, pass cards, PIN numbers, and/or dongles, among others. This can reduce the opportunity for these discrete items to be lost, stolen, or borrowed and used inappropriately. Further, where the unique identifier can be related to a set of permissions, the access to devices can be limited by unlocking only allowed devices. For example, where a new user has been hired, a fingerprint can be scanned in and attached to permission to use all company cell phones. Thereafter, the permissions can be stored for remote access by the improved locking system or can be disseminated (e.g., in an update form) to the satellite offices to update their local permissions. Further, the user permissions can be loaded onto memory devices, such as but not limited to, identity cards, flash memory drives, RFIDs, and the like, such that the user can present these devices to distributed locked devices. Thereafter, the user can use their fingerprint to unlock cell phones but not PDAs across the company's various properties. Further, the permissions system can later be updated to allow the user to access PDAs but not cell phones, thereafter, the user's fingerprint will only unlock PDAs and not cell phones. Further benefit is gained in that the permissions can be changed without requiring the user to turn in keys, dongles, pass cards, or to forget PIN numbers and passwords.

In an aspect of the disclosed subject matter, improved locking can occur by locks associated with the device, with the device mate (e.g., cradle, docking station, . . . ) or in auxiliary components (e.g., security tether, secure cabinet or drawer, . . . ). For example, a laptop can have a fingerprint scanner and locking device that can lock the laptop to a security cable, a cell phone cradle can have a voiceprint system and locking device that can lock various cell phones into the cradle, or a laptop can have a fingerprint scanner and the laptop docking station can have a locking device such that when the fingerprint is presented on the laptop the docking station unlocks the laptop, among many others.

In another aspect, inferences can be determined to facilitate improved locking. For example, inferences can be made based on physical location of the device, pulse rate of a user, historical access data (e.g., last user, typical device user, time since last use, . . . ), contextual information (time of day, distances between devices, number of available devices, condition of devices, . . . ), or user preferences, among a nearly limitless number of other factors. For example, where multiple cell phones are presented to a user who typically prefers cell phones with hearing aid compatibility, an inference can be made that the user would prefer a hearing aid compatible phone with less charge to a non-hearing aid compatible phone with a full charge. One of skill in the art will appreciate that the nearly limitless number of factors that can be included in an inferential determination can create a very powerful tool for improved mobile device locking and that all such factors are considered within the scope of the disclosed subject matter.

The subject innovation is hereinafter illustrated with respect to one or more arbitrary architectures for performing the disclosed subject matter. However, it will be appreciated by one of skill in the art that one or more aspects of the subject innovation can be employed in other memory system architectures and is not limited to the examples herein presented.

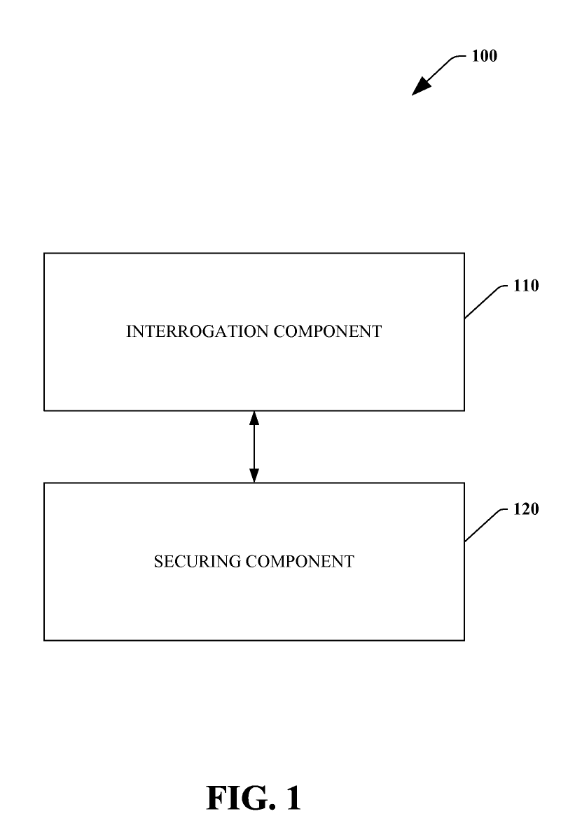

Turning to FIG. 1, illustrated is a system 100 that can facilitate improved locking. System 100 can include an interrogating component 110 to facilitate improved locking of mobile devices. Interrogation component 110 can facilitate interrogation of prospective users by accepting multiple unlocking inputs, such as, biometric inputs, mechanical key inputs, PIN inputs, password inputs, combination code inputs, swipe card inputs, dongle inputs, or combinations thereof and the like. For example, an interrogation input can determine a user's identity from a fingerprint, voiceprint, facial recognition, genetic identifier, or combinations thereof among others. These unique identifiers can, for example, be combined with a mechanical key to unlock and make available a cell phone from a charging cradle.

Interrogation component 110 can further include permissions data to improve the locking system. The permissions data can include for example, user identifiers and permission for devices, dates, times, levels of access, number of resources, or combinations thereof, among numerous others. For example, a user can be identified by fingerprint, hand structure, facial recognition, voiceprint, retinal scan, or combinations thereof, among others. Thus, a user can be identified by, for example, fingerprint and be allowed access, for example, to a cell phone and up to three mobile radios between the hours of 8 a.m. and noon, Monday through Thursday on a weekly basis. Further in this example, the user can be restricted to only a general corporate contact list on the cell phone (e.g., a list of executive phone numbers can be suppressed, among others).

In addition to biometric input and permissions data, interrogation component 110 can further accept user input. This can facilitate entry of passwords, pass codes, mechanical keys, RF information, and the like. Thus, a system can combine biometric keys with more traditional keys. For example, a user's hand print can be identified and a pass code can then be required to complete unlocking a device. This can prove useful in dual key security conditions, for example, where a manager approval is required for device unlocking. For instance, a user can present a fingerprint and a manager can present a pass code to complete device unlocking. Further, for example, a user can present a fingerprint and a manager can present a fingerprint and a shifting key code from a dongle to unlock the device. Numerous other possible permutations of multiple key systems are within the scope of the disclosed subject matter as herein disclosed.

Additionally, a communication system can be included in the interrogation component 110 to further facilitate device security. The communications system can communicate with other devices/systems to ascertain, for example, validation of the user's identification (e.g., biometric data can be stored in a central location as part of a distributed system, . . . ), updating of user permissions (e.g., user permissions are updated at regular intervals, updated at each device access, updated in response to an instruction to update, . . . ), logging of device access or attempted unlocking actions (e.g., update a device checkout list, update a log of attempted/successful device access, . . . ), or combinations thereof among others.

A remote access feature can also be included in an interrogation component 110 to facilitate device security. Instructions can be communicated to an improved locking system or device to initiate actions remotely. For example, a laptop can be unlocked from a docking station in a satellite office by a manager at a central office. Thus, where a prospective user calls into the central office, a manager can, in response to the verbal request, initiate the unlocking process remotely to provide the prospective user with access to the laptop resource.

An interrogation component 110 can further include an inferential component to determine inferences related to improved locking. These inferences can be based on a nearly limitless number of inputs. For example, inputs to the inferential component can include, but are not limited to, time, location, historic device use, historic device access, user profiles or secondary user data, weather or other environmental conditions, emergency conditions, device charge conditions, device maintenance alerts, predicted device use, anticipated device servicing, sales, available device resources, or combinations thereof, among numerous others. For example, an inference can be made that despite proper fingerprint identification, unlocking should not occur without further managerial approval because it is midnight and the employee identified by the fingerprint typically works from 9 a.m. to 5 p.m., and further because the identified employee's calendar indicates that they are in the middle of a three week vacation.

As a second example, where multiple cell phones are locked in a charging cradle, some weather resistant some not, a user can present a fingerprint that properly identifies the user. In response, an inference can be made that the user typically works outdoors doing survey work and the phone would likely be subject to weather conditions. A further inference can be made that the weather will be stormy (e.g., a weather data source can be accessed based on the user's typical or expected work location) and that a weather resistant phone should be provided. A further inference can be made that of the weather resistant phones locked in the cradle, some are more charged than others. Thus, based on the inferences, a fully charged, weather resistant phone can be unlocked for the user.

In an aspect, system 100 can further include a securing component 120 that can facilitate improved locking of mobile devices. Securing component 120 can include mechanical, electromechanical, magnetic, software or hardware locks, or combinations thereof, among others. Further, the securing component 120 can be included in a device, in a cradle or the like, be related to locking access to features or data, or some combination thereof among others. For example, the securing component 120 can be an electromechanical lock located in a laptop docking station that can communicate to the laptop that only a specific user profile can be opened based in part on the user unlocking the laptop.

Further, the securing component 120 can include analytics to facilitate securing devices. For example, the securing component 120 can determine that it is outside of a prescribed use location and in response lock the device against further use (e.g., shut down the device, disable further data access, lock out a keyboard or other input, shut down a display, . . . ). Thus, for instance, where a laptop contains confidential legal documents for use in a secure portion of a corporate office, when the user takes the laptop to an unsecure area, the laptop can be disabled, access to those documents can be terminated, or an alert can be activated, among others.

As a second example, where a user has permission to use a cell phone during normal working hours, the cell phone can lock out all use except for dialing emergency numbers outside of those normal hours. For instance, where an employee takes a company cell phone home over the weekend and has been assigned permission to make up to three hours of telephone calls to a client in Japan, the cell phone can lock out and prevent phone calls to anywhere except for the identified telephone number in Japan and after the hourly limit has been reached can further prevent later phone calls or even terminate the existing call in progress to prevent further use. Numerous other examples of analyzing device use for compliance with locking conditions are apparent and all such examples are considered within the scope of the subject innovation.

In an aspect, the interrogation component 110 and securing component 120 can be communicatively coupled to facilitate improved locking. Determinations and inferences made at the interrogation component 120 can be communicated to the securing component 120 to facilitate appropriate locking or unlocking actions therein. Moreover, this communicated information can contribute to analytic determinations in the securing component 120. Further, the locking conditions and states of the securing component 120 can be communicated to the interrogation component to facilitate further interrogation determinations and inferences. This can include providing additional device use information from analytics in the securing component 120 for future inferential determinations.

As an example, where a user repeatedly takes home a PDA, the analytic component can determine that the PDA is being used for personal use rather than business use and can communicate this determination to the interrogation component. Based in part on the analysis of personal use, an inference can be made that a manger approval is required for future device unlocking. Thus, where the user attempts to check out the PDA the following evening before heading home, the device can remain locked in the charging cradle until a manager approval is given.

Further, the communication between the interrogation component 110 and securing component 120 can be local, remote, or distributed. This can include internet and intranet communications, communication with subcomponents distributed over a network, communication between a base station and a device, interdevice communication, intradevice communication, or combinations thereof among others. For example, a cell phone with both an interrogation component 110 and securing component 120 inbuilt (e.g., the cell phone has, for example, a voiceprint identification system and an electromechanical lock built into it), can pass information between the inbuilt interrogation component 110 and securing component 120. Where, as a second example, a cell phone has a securing component 120 inbuilt and mates with a synchronization cradle having the interrogation component 110 inbuilt (e.g., the cell phone has an electromechanical lock and the cradle has a fingerprint scanner), the interrogation component 110 and securing component 120 can communicate when, for example, the cell phone is cradled, or by wireless communications (e.g., Wi-Fi, Bluetooth, by dialup, . . . ). Further, as a third example, where a laptop has a fingerprint scanner inbuilt and the remainder of the interrogation component 110 is distributed across several corporate server systems, and the docking station has a magnetic lock inbuilt and the remainder of the securing component 120 is located in the laptop as software, the interrogation component 110 and securing component 120 can communicate across appropriate communication systems such that the systems function logically as an interrogation component 110 and a securing component 120.

Employing a system 100 comprising an interrogation component 110 and securing component 120, can facilitate a more secure and highly improved locking system. This system can provide access to devices with high levels of specificity, can provide tracking of resources, can prevent use of resources outside of prescribed boundaries, and can provide the prospective user with the most appropriate device with a high level of transparency and ease of use. Further an improved locking system can be difficult to bypass and can require user compliance with the improved locking system parameters.

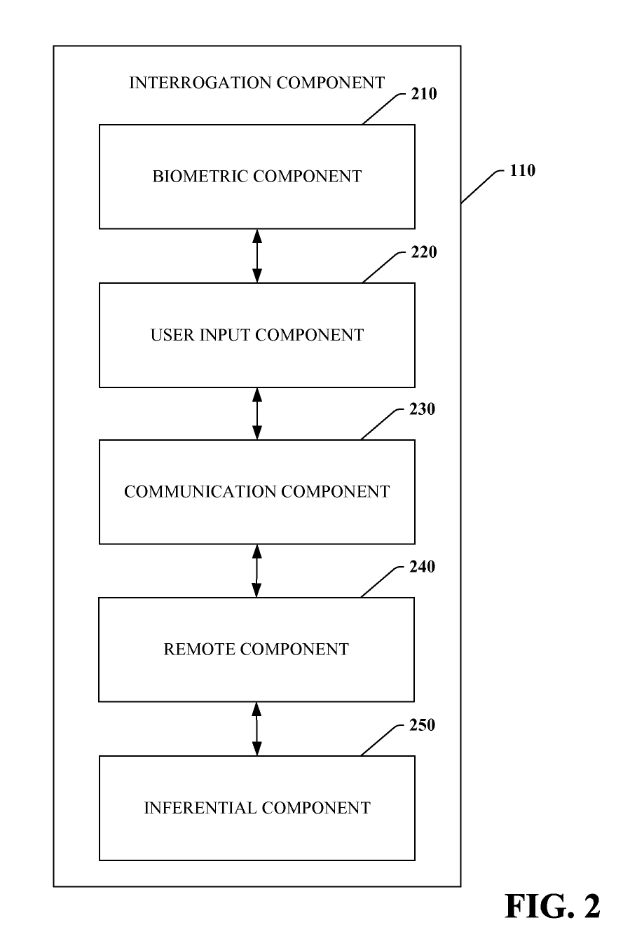

Referring now to FIG. 2, illustrated is an interrogation component 110 that can facilitate improved locking. The interrogation component 110 can include a biometric component 210 as described herein. The biometric component 210 can determine unique identifiers related to specific users. For example a fingerprint can be considered unique to a particular employee. Numerous biometric modalities can be employed as discussed herein, including but not limited to, fingerprints, voiceprints, facial recognition, genetic identification, retinal and iris prints, among others.

The interrogation component 110 can further include a user input component 220. The user input component can facilitate the use of more traditional methods of locking as described herein, including but not limited to, mechanical keys, pass codes, PIN numbers, dongles, and swipe cards, among others. These user inputs can be combined with inputs into the biometric component 210 to provide heightened levels of security as described herein.

Further, the biometric component 210 and user input component 220 can facilitate multiple permission systems. For example, a first user key and a second user fingerprint can be required to unlock a device. Similarly, a first user fingerprint and a second manager voiceprint can be required to unlock a device. Numerous other examples are possible and all are considered within the scope of the disclosed subject matter.

In an aspect, the interrogation component 110 can further include a communication component to facilitate improved locking. Information can be communicated to other devices and systems to further improve device security. For example, information related to a user's access of a device can be stored in a “check out” procedure and communicated to a central repository to facilitate user accountability of devices they have unlocked. Additionally, user permissions can be updated or checked through the communications component 230, for example to verify permission to unlock a device at the time the prospective user is trying to access the device.

Additionally, the conditions and states of other devices in an improved locking system 100 can be accessed through the communication component 230. For example, where a low priority user is attempting to unlock a cell phone, it can be determined that there are insufficient charged cell phones in the system to allow this user to unlock the device. In contrast, a high priority user could be allowed to unlock the device despite the limited number of charged cell phones in the system. As a second example, a user can attempt to unlock a PDA on the 3^{rd} floor after checking out a PDA on the 1^{st} floor. Where the 3^{rd} floor improved locking system can communicate through the communication component 230, it can be determined that the user should not have access to two PDAs and the unlock request on the 3^{rd} floor can be denied until the PDA on the first floor is returned. Numerous other communications examples are possible and all such examples are considered with the scope of the disclosed subject matter.

In another aspect, a remote component 240 can be included in the interrogation component 110 as herein described. For instance, the remote component 240 can permit remote unlocking of the device. For example, where a user's device has become locked because he has taken it outside of the prescribed area of use, the locked state can be unlocked by, for example, a manager giving remote permission.

In a further aspect, the interrogation component can comprise an inferential component 250 to facilitate improved locking as described at length herein. The inferential component 250 can determine inferences based on a nearly limitless number of factors to optimize improved locking. For example, based on employee A checking out a laptop, employee B can be denied a laptop based on an inference that only one laptop is needed for a presentation by employees A and B to a client. As a second example, an inference that a GPS enabled cell phone should be unlocked from a bank of locked cell phones can be based on the prospective user's history of needing GPS enabled cell phones for business trips. Numerous other more complex inferences can be described and all are considered within the scope of the subject innovation.

The components included in the interrogation component 110 can be communicatively coupled to further optimize an improved locking system 100. For example, where a fingerprint biometric is repeatedly difficult to acquire from a particular user because they have very weak fingerprints, this information can be passed to the inferential component, such that an alternate biometric can be used when the user inputs a PIN into the user input component 220 before attempting to unlock a device with a biometric. Similarly, communication between components can facilitate improved locking by, for example, relying more on inferences from the inferential component 250 in response to information from the communication component 230 that communications are not optimal.

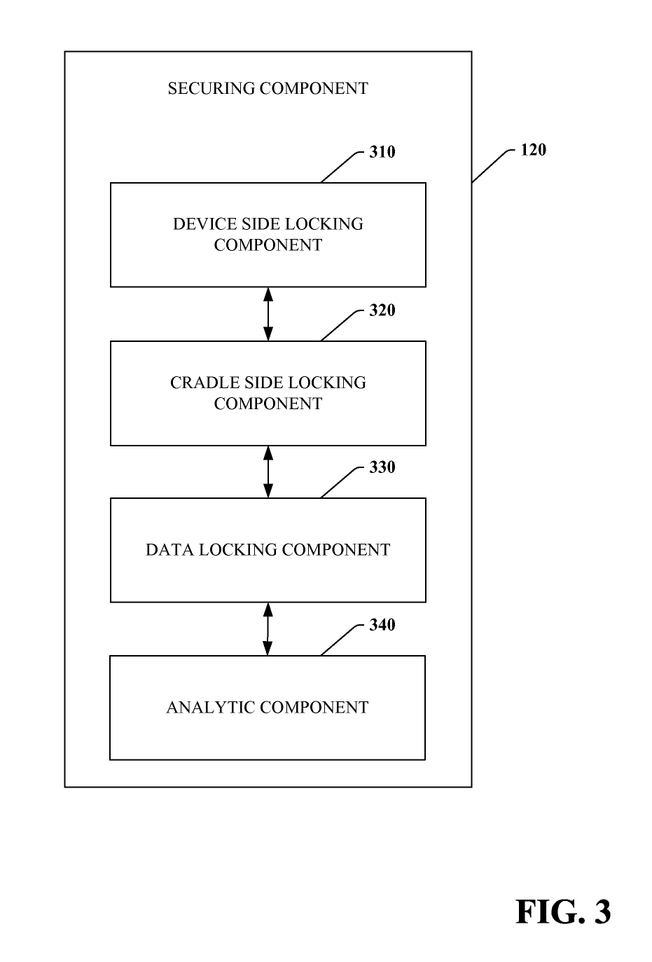

Referring now to FIG. 3, illustrated is a securing component 120 to facilitate improved locking in accordance with an aspect of the disclosed subject matter. The securing component 120 can include a device side locking component 3 10. This device side locking component 310 can include a locking means as herein discussed to facilitate locking the device to improve device security. For example, the device side locking component 310 can include an electromechanical lock and a software lock, wherein the electromechanical lock secures the device to a standard security cable and the software lock prevents operation of the operating system until the device is unlocked.

The securing component 120 can also include a cradle side locking component 320. This cradle side locking component 320 can include a locking means, as herein discussed, to facilitate locking the device to improve device security. For example, the cradle side locking component can include a magnetic lock to secure devices thereto. It will be appreciated that a cradle side locking component 320 is not specifically limited to cradles but can further include any device mating device or storage system. For example, the cradle side locking component 320 can be part of a cradle, docking station, synchronization cable, multiport cradle, equipment drawer, belt clip, or desk mount security device, among many others.

A data locking component 330 can also be included in the securing component 120 to facilitate improved locking. Data locking can include limiting access to data by way of software, software and hardware, or hardware alone (e.g., locking an operating system, requiring a dongle, or locking a hard drive, respectively, among numerous other examples). Data access can also be limited over remote connections, such as but not limited to, Wi-Fi access, FTP, remote logon, and the like. Data locking can occur over a distributed system.

In an aspect, securing component 120 can further include an analytic component 340 as herein described. The analytic component 340 can aid in determining compliance with prescribed locking conditions, determine violation of rules related to allowed device, user, and/or data access, and can initiate limitation of use in response to any violations. Further, the analyzed access patterns can be communicated to other system components to improve device security in a proactive manner.

Components of the securing component 120 can be communicatively coupled to improve locking and optimize performance. For example, locking states between a cradle side locking component 320 and a device side locking component 310 can be compared to ensure that all locking conditions are satisfied before altering the locking state. Similarly, analysis of device use can be communicated to the data locking component 330 to cause data access limitation to be put into effect where appropriate.

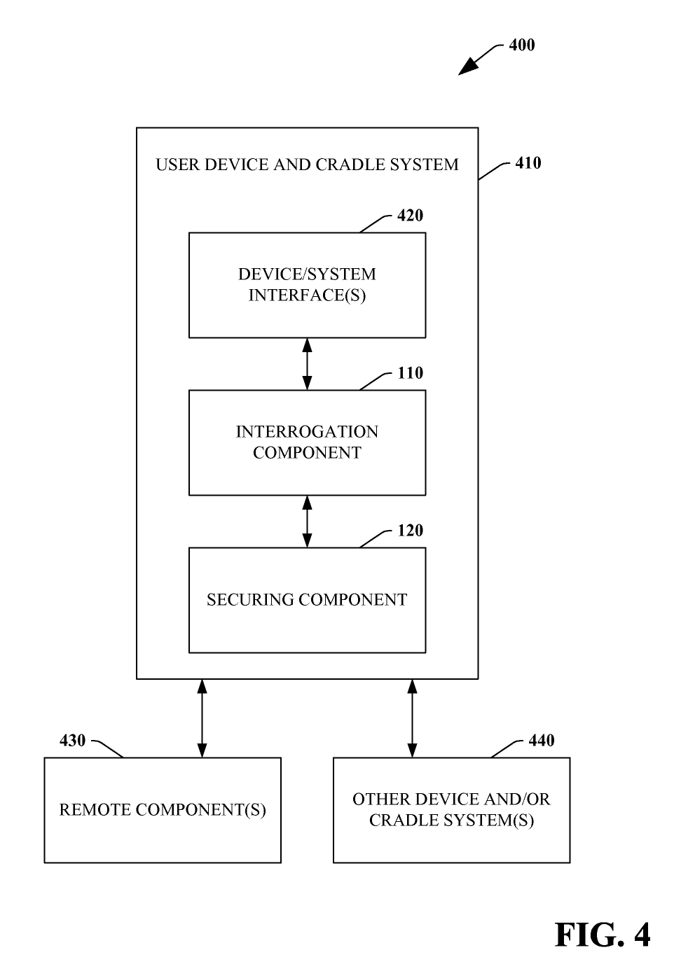

Referring now to FIG. 4, illustrated is an exemplary system 400 comprising a user device and cradle system 410 (UDCS) employing an improved locking system 100 that can facilitate improved locking of devices in accordance with an aspect of the disclosed subject matter. It will be appreciated that as used herein a cradle can refer to any device mate or other locking modality as described herein (e.g., a cradle, a docking station, a multiport docking station, a security drawer or cart, a security tether, . . . ). The UDCS 410 can include a device/system interface 420 that can facilitate user interaction. For example, the device/system interface 420 can include a graphical user display, a keyboard, a mouse, a touch screen, a microphone, a speaker, a biometric sensor, a mechanical lock, a magnetic reader, a bar code reader, or a RFID reader, among many others.

The UDCS 410 can further include an interrogation component 110 and a securing component 120 as herein described for facilitate improved locking. For example, the user UDCS 410 can have a fingerprint reader as part of the device/system interface 420 that can provide a fingerprint scan to the interrogation component 110. At the interrogation component 110 it can be determined that the fingerprint matches the reference fingerprint of user A. Further at the interrogation component 110 it can be inferred that a PDA with a GPS is preferable based in part on user A's previous repeated selection of GPS enabled PDAs. The preference and identity determination can be passed to the securing component 120, for example, an electromechanical PDA cradle lock, such that the electromechanical lock can be unlocked releasing a GPS enabled PDA to user A.

The UDCS 410 can be communicatively coupled to remote component(s) 430, which can include, for example, a remote permissions database, a remote manager's terminal, a remote equipment tracking system, or combinations thereof, among others. Thus, for example, the PDA unlocked for user A can be recorded in a remote check out system as checked out to user A, such that user A is accountable for the PDA.

Further, the UDCS 410 can be communicatively coupled to other device and/or cradle systems 440 to facilitate improved locking. For example, if user A attempts to unlock a second PDA, it can be determined that user A has already checked out a first PDA and the second PDA will not be unlocked. Further, where user A checks in the first PDA at a second location, user A can be allowed to check out a second PDA at any other location, for example, at location 3.

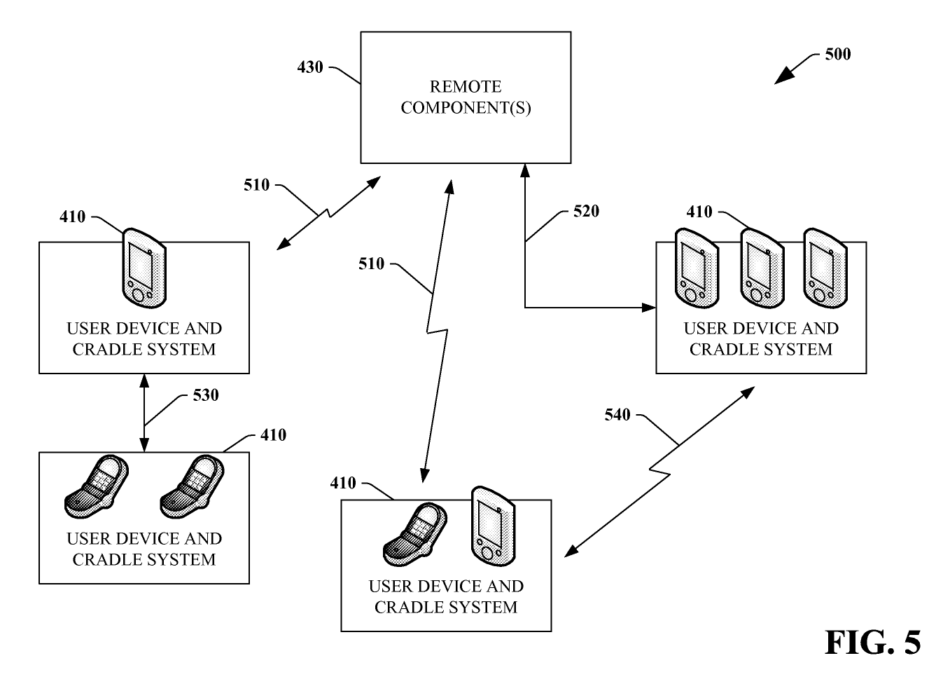

Referring now to FIG. 5, a schematic illustration of a system to facilitate improved locking of devices in accordance with an aspect of the disclosed subject matter is illustrated. In an aspect, remote components 430 can be a central server system, among others. In a central server system, a plurality of UDCS 410 can be communicatively couple to the remote components 430 to facilitate improved locking. These connections can be by wireless connections 510, for example, cellular networks, WLAN, Wi-Fi, internet or intranet with wireless components, or combinations thereof, among others. Further the connection can be by wired connections 520, for example, internet or intranet wired systems, among others. This can enable aspects of the system 100 to be distributed between the remote components 430 and the plurality of UDCS 410. For example, a UDCS 410 cradle can have a fingerprint reader that communicates a scanned fingerprint to the remote components 430 for user identification and a determination of locking condition. This determination can be communicated back to the UDCS 430 securing component (not illustrated) to unlock the device for a verified user.

The plurality of UDCS 430 can also be interconnected. They can be interconnected as a daisy chain 530 such that a second UDCS 410 can communicate with a remote component 430 through a first UDCS 410. Thus, banks of UDCS 410 can functionally act in a manner similar to a multiport UDCS 410. Further the connection between UDCS 410 can be similar to an ad hoc computer network 540. This can allow UDCS 410 to maintain a secure improved locking system even where primary communication channels have been disturbed.

Additionally, where UDCS 410 can communicate with other UDCS 410, this can be through direct communication (e.g., such as the ad hoc network 530, among others) or through hub and spoke communication employing aspects of the remote components 430. For example a first HDCS 410 can communicate with a second remote UDCS 410 by passing a message through the remote component 430. This can allow all UDCS 410 to stay up to date as to locking conditions and permissions, among others.

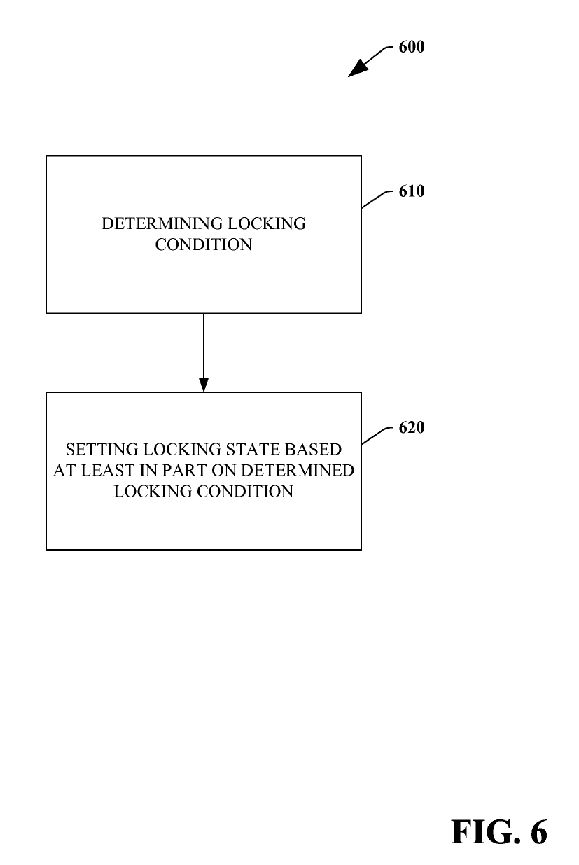

FIGS. 6-9 illustrate methodologies, flow diagrams, and/or timing diagrams in accordance with the disclosed subject matter. It is to be appreciated that the methodologies presented herein can incorporate actions pertaining to a neural network, an expert system, a fuzzy logic system, and/or a data fusion component, or a combination of these, which can generate diagnostics indicative of the optimization of an improved locking system germane to the disclosed methodologies. Further, the prognostic analysis of this data can serve to optimize an improved locking system, and can be based on real time acquired data or historical data within a methodology or from components related to a methodology herein disclosed, among others. It is to be appreciated that the subject invention can employ highly sophisticated diagnostic and prognostic data gathering, generation and analysis techniques, and such should not be confused with trivial techniques (e.g., simply unlocking a software application in response to a recognized fingerprint scan).

For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states by way of a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 6, illustrated is a methodology 600 that facilitates improved locking. Conventional methodologies frequently employ simple mechanical keys, passwords, PINs, or magnetic swipe cards to unlock devices. These methodologies are subject to loss, damage, circumvention, and human memory errors. For example, conventional methodologies can result in a lost key that can be used to access equipment without authorization, for example, a manger can lose a key to a PDA charger, said key can be found by an employee that will soon be quitting the company, such that said employee can access a PDA without permission.

The methodology 600 can facilitate improved locking by employing biometric systems to uniquely identify prospective users. At 610, methodology 600 can determine a locking condition. A locking condition can be a determination of a user's identity, the permissions the user is associated with in regards to equipment access, the conditions and availability of equipment, or combinations thereof, among others. For example, a locking condition can indicate that user A has been identified by facial recognition, that user A has permission to unlock a laptop, and that there are three laptops available that are in good condition and fully charged.

At 620, methodology 600 can set a locking state based at least in part on the locking condition determination. A locking state can be unlocking a device, locking a device, limiting access levels within a device, or combinations thereof, among others. For example, of the three identified laptops available to user A, based on the locking condition that user A can unlock one laptop, a single laptop can be unlocked such that user A has access to said laptop. Similarly, as part of setting the locking condition at 620, the released laptop can be software locked to allow user A to log in only under user A's profile (e.g., user A can have limited access to data on the laptop). At this point, methodology 600 can end.

In an aspect, determining the locking condition at 610 can include any of the various biometric determinations herein discussed at length. For example, facial recognition, fingerprints, voiceprints, hand structure, retinal and iris scans, genetic identification, among numerous others. Further, as also herein discussed, several layers of identification can be employed such that more than one biometric identifier is required (e.g., two or more user biometrics, at least one user and one manager biometric, two or more biometrics for other authorized persons, . . . ). Additionally, biometrics can be combined with other identification means, as discussed herein (e.g., mechanical keys, swipe cards, dongles, . . . ).

Determining the locking condition at 610 can further include, accountability actions, such as but not limited to, check out systems identifying equipment with the party unlocking it. Further, remote oversight and management of equipment can be executed under determining the locking condition at 610, such as, remote unlocking, distributed permission systems, and others as herein discussed. [0076] In another aspect, system 600 can employ various locking modalities on which the locking state can be set at 620. These can include, among others, locks in devices, locks in cradles and the like, and aftermarket locks. Further, data locks and system access locks can be set at 620 as herein discussed. For example, when unlocking a laptop, the lock can be located in the laptop, in the docking station, or can be, for example, a locking tether, among others. Continuing the example, access on the laptop can be limited to, for example, signing into a specific user profile, access only to certain databases and software, using the laptop as read only, or combinations thereof, among others, as part of setting the locking state.

Methodology 600 can further employ inferences as herein described to optimize the improved locking system. For example, inferences can be determined that user A needs to check out a laptop with special software, such that only a single laptop having that software can be unlocked for user A. Similarly, it can be inferred that user A can need access to specific databases on the laptop such that those databases can be made available to user A through user A's profile (e.g., where user A is limited to logging into only user A's profile.)

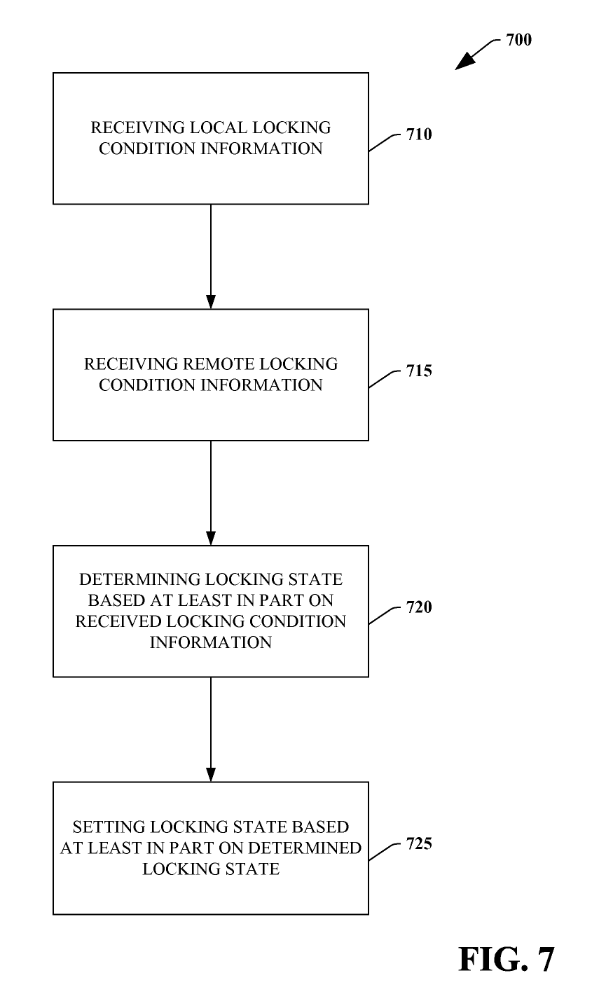

Referring now to FIG. 7, illustrated is a methodology 700 that facilitates improved locking. At 710, methodology 700 can receive local locking condition information. This can include receiving biometric information, among others, to facilitate improved locking. For example, a fingerprint scanner can locally receive the fingerprint scan. At 715, remote locking condition information can be received. For example, a list of permissions for the user identified by the fingerprint scan can be received by methodology 700. At 720 the locking state can be determined. This can include determinations and inferences related to the locking conditions received locally and remotely.

For example, where a user has been identified by fingerprint and permissions have been received relating to the identified user, it can further be determined what equipment meets the permissions and is in serviceable condition. Further, any special needs can be determined, such as where the user is identified as being visually impaired, a need for a PDA with text to speech technology can be indicated. In response to the determinations and inferences of the locking condition, a locking state can be determined. This can include identifying a PDA with text to speech technology to unlock for the identified user.

At 725, the system 700 can set the determined locking state. Setting the locking state includes unlocking, locking, or limiting access on equipment identified in the determination of the locking state at 720. This can include, for example, unlocking the PDA with text to speech technology. It can further include limiting access, for example, limiting outgoing telephone calls to local telephone calls on the PDA for user A. After this, method 700 can end.

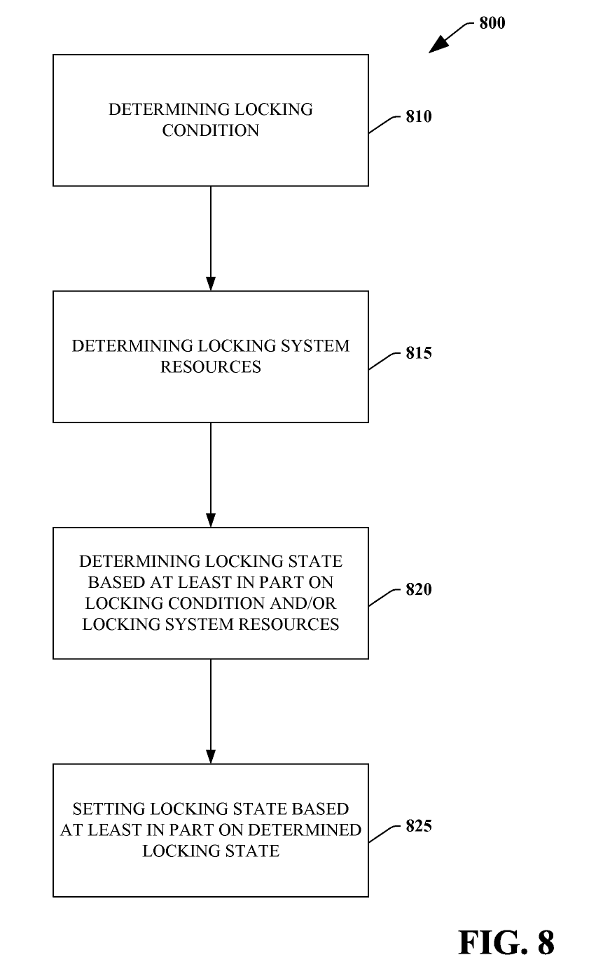

Referring now to FIG. 8, illustrated is a methodology 800 that facilitates improved locking. At 810 a locking condition can be determined as described herein. This can include identifying a prospective user, determining permissions, determining specific needs, or combinations thereof, among others. At 815, locking system resources can be determined. Locking system resources include locked devices and systems and data available on the locked devices or through the locked devices. This can further include device capabilities. For example, a determination of locking system resources can include identifying PDAs with text to speech technology, weather resistant cell phones, or laptops with special software, among many others.

At 820, the locking state can be determined based at least in part on the locking condition and the locking system resources determined. The locking state can further include determinations, such as, device charge conditions, device wear leveling, device availability, user priority, or combinations thereof, among others, as described herein. For example, it can be determined that only one PDA with text to speech is available and that user B has a higher priority to these devices that user A. Where it is further determined that user B has reserved the PDA, user A can be denied access to the PDA although a second PDA without the text to speech can be made available. At 825, the locking state can be set as herein described. After this, method 800 can end.

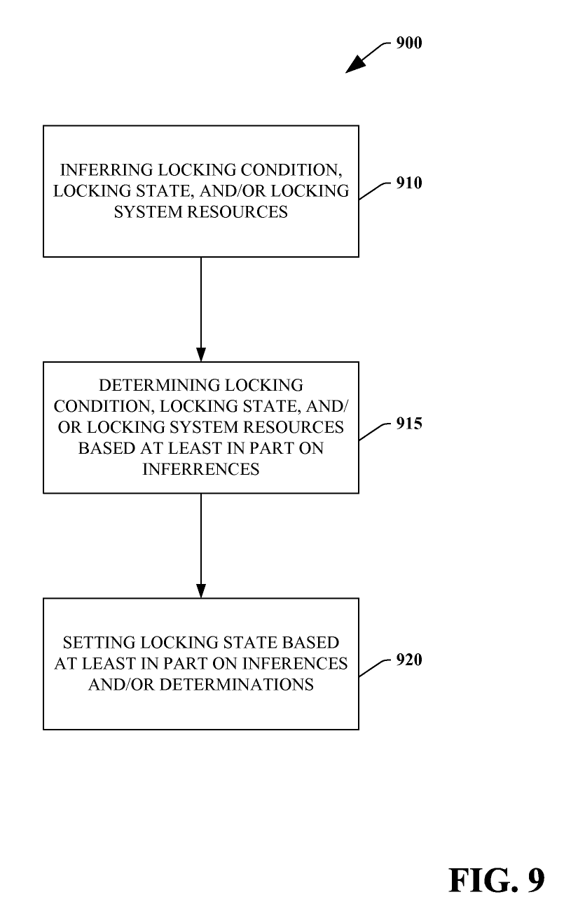

Referring now to FIG. 9, illustrated is a methodology 900 that facilitates improved locking. At 910, the locking condition, locking state, and/or locking system resources can be inferred. Where sufficient information is available, inferences can provide highly optimized resource management in cooperation with the improved locking system.

For example, a locking condition can be inferred that a user has permissions even where direct confirmation of these permissions cannot be achieved due to, for example, a crashed network. Thus, rather than denying the user access to a device because of a communications error, the user can be inferred to have certain permissions based on prior device usage and permissions associated with those accesses. Similarly, a locking state can be inferred, for example, when a device is running a particular version of software it can be inferred that certain features are available without direct confirmation that those features are indeed available. Also similarly, a locking system resource can be inferred, for example, it can be inferred that a device is fully charged where it was charged when it was previously checked out and was returned within, for example, 5 minutes. These simple examples are only intended to illustrate that inferences can be determined and that by combining simple inferences, more complex inferences can be made.

At 915, the locking condition, locking state, and locking system resources can have determinations made about them based in part on the inferences made at 910. For example, where an inference has been made that an indentified user can have certain permissions based on prior use, the locking condition can be determined to provide that inferred level of permission. Similar examples can be made for locking state and locking system resources. At 920, based in part on the inferences and/or determinations made about the locking condition, locking state, and locking system resources, the locking state can be set as herein described. Setting the locking state can result in unlocking, locking, or setting access levels for a device to be checked out. After this, method 900 can end.

It is to be appreciated that more complex inferential determinations can be made regarding locking condition, locking state, and locking system resources, as discussed herein. It is to be further appreciated that further inferences and determinations can be based at least in part on determinations about locking condition, locking state, and locking system resources as also discussed herein. All such modifications of method 900 are considered to be within the scope of the disclosed subject matter.

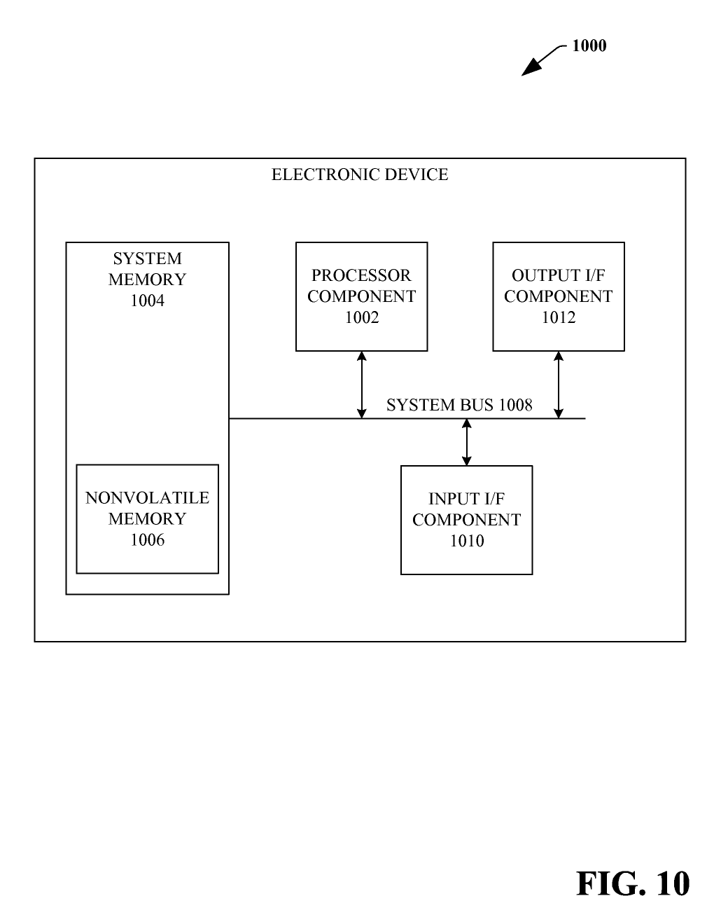

Referring to FIG. 10, illustrated is a block diagram of an exemplary, non-limiting electronic device 1000 that can facilitate location optimization in accordance with one aspect of the disclosed subject matter. The electronic device 1000 can include, but is not limited to, a computer, a laptop computer, barcode scanners, optical scanners, network equipment (e.g. routers, access points), a media player and/or recorder (e.g., audio player and/or recorder, video player and/or recorder), a television, a smart card, a phone, a cellular phone, a smart phone, an electronic organizer, a PDA, a portable email reader, a digital camera, an electronic game (e.g., video game), an electronic device associated with digital rights management, a Personal Computer Memory Card International Association (PCMCIA) card, a trusted platform module (TPM), a Hardware Security Module (HSM), set-top boxes, a digital video recorder, a gaming console, a navigation system (e.g., global position satellite (GPS) system), secure memory devices with computational capabilities, devices with tamper-resistant chips, an electronic device associated with an industrial control system, an embedded computer in a machine (e.g., an airplane, a copier, a motor vehicle, a microwave oven), and the like.

Components of the electronic device 1000 can include, but are not limited to, a processor component 1002, a system memory 1004 (with nonvolatile memory 1006), and a system bus 1008 that can couple various system components including the system memory 1004 to the processor component 1002. The system bus 1008 can be any of various types of bus structures including a memory bus or memory controller, a peripheral bus, or a local bus using any of a variety of bus architectures.

Electronic device 1000 can typically include a variety of computer readable media. Computer readable media can be any available media that can be accessed by the electronic device 1000. By way of example, and not limitation, computer readable media can comprise computer storage media and communication media. Computer storage media can include volatile, non-volatile, removable, and non-removable media that can be implemented in any method or technology for storage of information, such as computer readable instructions, data structures, program modules or other data. Computer storage media includes, but is not limited to, RAM, ROM, EEPROM, nonvolatile memory 1006 (e.g., flash memory), or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by electronic device 1000. Communication media typically can embody computer readable instructions, data structures, program modules or other data in a modulated data signal such as a carrier wave or other transport mechanism and includes any information delivery media.

The system memory 1004 can include computer storage media in the form of volatile and/or nonvolatile memory 1006. A basic input/output system (BIOS), containing the basic routines that help to transfer information between elements within electronic device 1000, such as during start-up, can be stored in memory 1004. Memory 1004 can typically contain data and/or program modules that can be immediately accessible to and/or presently be operated on by processor component 1002. By way of example, and not limitation, system memory 1004 can also include an operating system, application programs, other program modules, and program data.

The nonvolatile memory 1006 can be removable or non-removable. For example, the nonvolatile memory 1006 can be in the form of a removable memory card or a USB flash drive. In accordance with one aspect, the nonvolatile memory 1006 can include flash memory (e.g., single-bit flash memory, multi-bit flash memory), ROM, PROM, EPROM, EEPROM, or NVRAM (e.g., FeRAM), or a combination thereof, for example. Further, the flash memory can be comprised of NOR flash memory and/or NAND flash memory.

A user can enter commands and information into the electronic device 1000 through input devices (not shown) such as a keypad, function buttons, trigger, microphone, graphical user interface, tablet or touch screen although other input devices can also be utilized. These and other input devices can be connected to the processor component 1002 through input interface component 1012 that can be connected to the system bus 1008. Other interface and bus structures, such as a parallel port, game port or a universal serial bus (USB) can also be utilized. A graphics subsystem (not shown) can also be connected to the system bus 1008. A display device (not shown) can be also connected to the system bus 1008 via an interface, such as output interface component 1012, which can in turn communicate with video memory. In addition to a display, the electronic device 1000 can also include other peripheral output devices such as speakers (not shown), which can be connected through output interface component 1012.

It is to be understood and appreciated that the computer-implemented programs and software can be implemented within a standard computer architecture. While some aspects of the disclosure have been described above in the general context of computer-executable instructions that may run on one or more computers, those skilled in the art will recognize that the technology also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices (e.g., PDA, phone), microprocessor-based or programmable consumer electronics, and the like, each of which can be operatively coupled to one or more associated devices.

The illustrated aspects of the disclosure may also be practiced in distributed computing environments where certain tasks are performed by remote processing devices that are linked through a communications network. In a distributed computing environment, program modules can be located in both local and remote memory storage devices.

As utilized herein, terms “component,” “system,” “interface,” and the like, can refer to a computer-related entity, either hardware, software (e.g., in execution), and/or firmware. For example, a component can be, but is not limited to being, a process running on a processor, a processor, a circuit, a collection of circuits, an object, an executable, a thread of execution, a program, and/or a computer. By way of illustration, both an application running on a server and the server can be a component. One or more components can reside within a process and a component can be localized on one computer and/or distributed between two or more computers.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) .. ), smart cards, and flash memory devices (e.g., card, stick, key drive. .. ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the disclosed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

### Artificial Intelligence

Artificial intelligence based systems (e.g., explicitly and/or implicitly trained classifiers) can be employed in connection with performing inference and/or probabilistic determinations and/or statistical-based determinations as in accordance with one or more aspects of the disclosed subject matter as described herein. As used herein, the term “inference,” “infer” or variations in form thereof refers generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

For example, an artificial intelligence based system can evaluate current or historical evidence associated with data access patterns (e.g., historic user permissions, features desired in previous device accesses, special user needs, or combinations thereof, among others, . . . ) and based in part in such evaluation, can render an inference, based in part on probability, regarding, for instance, unlocking a device with text to speech technology, among many others. One of skill in the art will appreciate that intelligent and/or inferential systems can facilitate further optimization of the disclosed subject matter and such inferences can be based on a large plurality of data and variables all of with are considered within the scope of the subject innovation.

What has been described above includes examples of aspects of the disclosed subject matter. It is, of course, not possible to describe every conceivable combination of components or methodologies for purposes of describing the disclosed subject matter, but one of ordinary skill in the art will recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system for determining access to a mobile asset comprising:
an interrogation component that can at least determine a user identity based in part on a received biometric input; and
a securing component that can at least unlock a device based at least in part on the determined user identity.

2. The system of claim 1, wherein the interrogation component can further receive a non-biometric key to facilitate determining access to a mobile asset.

3. The system of claim 2, wherein the non-biometric key is a mechanical key, an alpha-numeric sequence, a magnetic swipe card, a dongle, combination code, or combinations thereof.

4. The system of claim 1, further comprising at least one biometric component that can at least in part determine a unique identifier based on a fingerprint, facial recognition, voice recognition, genetic information, hand configuration, retinal information, iris information, biofeedback, or combinations thereof.

5. The system of claim 1, further comprising an inferential component that can determine an inference relating to the user identity based at least in part on historic device use, historic feature preference, weather, time, date, day, available assets, historic permissions, or combinations thereof.

6. The system of claim 1, further comprising an electromechanical lock, a magnetic lock, an electromagnetic lock, a software lock, a hardware lock, a combination hardware and software lock, a data access lock, or combinations thereof.

7. The system of claim 6, wherein the lock is part of the mobile asset, part of a mate to the mobile asset, part of a cradle, part of a multiport cradle, part of a docking station, part of an equipment locker, part of an equipment drawer, part of a security tether, part of an aftermarket security device, or combinations thereof.

8. The system of claim 1, wherein the system is selectively communicatively coupled to remote components to facilitate a distributed system for determining access to a mobile asset.

9. The system of 8, wherein the remote components are one or more servers serving information related to determining access to a mobile asset.

10. The system of claim 1, wherein the system is selectively communicatively coupled with other mobile asset systems or other mobile assets to facilitate determining access to a mobile asset of any communicatively coupled system.

11. An electronic device comprising the system of claim 1.

12. The electronic device of claim 11, wherein the electronic device comprises at least one of a computer, a laptop computer, barcode reader, network equipment, a media player, a media recorder, a television, a smart card, a phone, a cellular phone, a smart phone, an electronic organizer, a personal digital assistant, a portable email reader, a digital camera, an electronic game, an electronic device associated with digital rights management, a Personal Computer Memory Card International Association (PCMCIA) card, a trusted platform module (TPM), a Hardware Security Module (HSM), set-top boxes, a digital video recorder, a gaming console, a navigation system, a secure memory device with computational capabilities, a device with at least one tamper-resistant chip, an electronic device associated with industrial control systems, or an embedded computer in a machine, or a combination thereof, wherein the machine comprises one of an airplane, a copier, a motor vehicle, or a microwave oven.

13. A method that facilitates determining access to a mobile asset comprising:
determining a locking condition wherein at least the identity of a user can be determined or inferred; and
setting the locking state based at least in part on the determined locking condition, wherein the locking state can be a mobile asset is locked, a mobile asset is unlocked, a data access level is set in a mobile asset, or combinations thereof.

14. The method of claim 13, wherein biometric information can be determined or inferred as part of determining a locking condition.

15. The method of claim 13, wherein user permissions can be determined or inferred as part of determining a locking condition.

16. The method of claim 13, wherein mobile asset features can be determined or inferred as part of determining a locking condition.

17. The method of claim 13, wherein mobile asset conditions can be determined or inferred as part of determining a locking condition.

18. The method of claim 13, wherein the quantity of mobile assets, types of mobile assets, attributes of mobile assets, or combination thereof can be determined or inferred as part of determining a locking condition.

19. The method of claim 13, wherein the locking state can be determined or inferred based at least in part on determinations, inferences, or combinations thereof, relating to the locking condition.

20. The method of claim 13, wherein the locking state can be set as mobile asset locked, mobile asset unlocked, mobile asset data access level set, or combinations thereof, based at least in part on the determined or inferred locking state.
